(19) United States
(12) Patent Application Publication
(10) Pub. No.: US 2017/0339992 A1
(43) Pub. Date: Nov. 30, 2017

(54) REDUCED CALORIE NUT BUTTER COMPOSITIONS

(71) Applicant: Choco Finesse LLC, Indianapolis, IN (US)

(72) Inventors: Leopold STRECKER, Warren, NJ (US); David Rowe, Indianapolis, IN (US); Dana Overman, Roswell, GA (US); Louie Flowers, Greenville, SC (US)

(73) Assignee: Choco Finesse LLC, Indianapolis, IN (US)

(21) Appl. No.: 15/164,250

(22) Filed: May 25, 2016

(51) Int. Cl. A23L 25/10; A23L 25/00

(52) U.S. Cl. CPC A23L 25/10; A23L 25/30; A23V 2002/00

(57) ABSTRACT

Nut butter compositions which are reduced in calories and fat are prepared using defatted nut flour, vegetable oil, and certain esterified propoxylated glycerol compositions.

### FIELD OF THE INVENTION

The present invention has to do with reduced calorie nut butter compositions. More particularly, the invention relates to nut butter spreads which are prepared by employing certain fatty acid-esterified propoxylated glycerol compositions. The compositions of the invention have the flavor, texture and organoleptic character of full-calorie nut butter products, including the capability of being readily and smoothly spread at ambient (room) temperatures due to the ability of the fatty acid-esterified propoxylated glycerol compositions to form eutectic blends with natural fats and oils. Additionally, the nut butter products may not require stabilizers which are necessary for conventional full-calorie nut butters and certain reduced calorie nut butter compositions known in the art and have a reduced tendency to exhibit the passive oil loss issues sometimes observed for food products based on fat substitutes of low digestibility.

### BACKGROUND OF THE INVENTION

Nut butters such as peanut butter are high protein nutritious foods but their consumption is believed to be limited by segments of the population who are reducing their caloric intake. Nut butters having reduced calories are desirable to consumers but it has been difficult for formulators to maintain the flavor, texture and organoleptic character of full-calorie nut butter products.

Applicants now have discovered that certain fatty acid-esterified propoxylated glycerol compositions (sometimes referred to herein simply as “esterified propoxylated glycerol compositions”) may be used to prepare nut butters which have reduced calories, excellent flavor, texture and organoleptic characteristics and which still provide high protein and nutrition. In addition, these nut butters possess the desirable characteristic that stabilizers may be unnecessary in their formulation as a result of the properties resulting from the selection of the fatty acid-esterified propoxylated glycerol composition. In certain embodiments, the fat component of these compositions do not separate, thus no stabilizers are necessary, and thereby allowing for further calorie reduction. The reduced calorie content resulting from the absence of stabilizers in the composition is in addition to the significant calorie reduction achieved through use of the fatty acid-esterified propoxylated glycerol compositions. A further advantage of the esterified propoxylated glycerol compositions utilized in the present invention is that persons consuming the nut butters based on these esterified propoxylated glycerol compositions experience few, if any, problems with passive oil loss, due to the relatively high melting point (Mettler drop point) of the esterified propoxylated glycerol compositions.

While the present specification makes reference to nut butters and specifically to peanuts and peanut spreads, it is understood that the principles of the invention apply to legumes, nuts and seeds other than peanuts, such as cashews, almonds, walnuts, filberts, macadamia nuts, pistachios, Brazil nuts, pecans, soybeans, sunflower seeds, pumpkin seeds, sesame seeds (tahini), coconut and the like. All percentages and ratios set forth herein are on a weight/weight basis unless specifically designated otherwise.

### SUMMARY OF THE INVENTION

One aspect of the invention provides a reduced calorie and reduced fat nut butter composition comprising:

a) defatted nut flour;

b) vegetable oil; and

c) an esterified propoxylated glycerol composition having an average propoxylation number of from about 4 to about 6, an Iodine Value greater than 10 (preferably, at least about 15), a Mettler drop point of at least about 38° C., and a solid fat content profile as follows:
about 65 to about 75 at 10° C.;
about 58 to about 68 at 20° C.;
about 43 to about 55 at 25° C.;
about 30 to about 40 at 30° C.;
about 18 to about 25 at 35° C.; and
less than about 0.5 at 40° C.

In one embodiment, the defatted nut flour is roasted. The defatted nut flour in one aspect of the invention is defatted peanut flour. The defatted nut flour may contain some amount of residual oil (e.g., about 5 to about 20 weight %). Defatted nut flour may constitute about 30 to about 55 weight % of the nut butter composition, according to one embodiment of the invention.

The vegetable oil in one aspect of the invention may be a nut oil, such as peanut oil. The vegetable oil may, in one embodiment, constitute from about 5 to about 30 weight % of the nut butter composition. In another embodiment, vegetable oil constitutes from about 10 to about 25 weight % of the nut butter composition. The total amount of vegetable oil present in the nut butter composition includes vegetable oil present in all the components of the nut butter composition, not just separately added (pure) vegetable oil. For example, vegetable oil may be present in a ground or milled nut paste component of the formulation and/or the defatted nut flour.

In one embodiment, the esterified propoxylated glycerol composition may constitute about 20 to about 40 weight percent of the nut butter composition. The esterified propoxylated glycerol composition may, in one embodiment, have an average propoxylation number of from about 4 to about 6 (e.g., about 5). The esterified propoxylated glycerol may, in one aspect of the invention, contain fatty acid ester groups obtained from a fatty acid mixture comprised of about 5 to about 30 weight percent liquid soybean oil fatty acids and about 20 to about 30 weight percent behenic acid, with the balance of the fatty acids selected from the group consisting of arachidic acid, stearic acid, palmitic acid and combinations thereof. In another aspect of the invention, the esterified propoxylated glycerol composition is the reaction product of glycerol propoxylated with an average of about 5 moles of propylene oxide per mole of glycerol that has been esterified with a fatty acid composition comprised of:
a) about 50 to about 70% by weight of one or more C20-C22 saturated fatty acids;
b) about 23 to about 27% by weight of one or more C18 unsaturated fatty acids;
c) up to about 5% by weight of one or more fatty acids other than C20-C22 saturated fatty acids, C18 unsaturated fatty acids and C16-C18 saturated fatty acids; and
d) the balance to a total of 100% by weight of one or more C16-C18 saturated fatty acids.

The propoxylation number and fatty acid ester content of the esterified propoxylated glycerol composition may be selected such that the Mettler drop point of the composition is not more than about 40° C. and not less than 38° C.

In various aspects of the invention, the nut butter composition does not contain one or more of the following components: full fat nuts, stabilizer and bulking agent. The nut butter composition may, however, additionally comprise at least one further ingredient selected from the group consisting of salt and sweeteners, in addition to the defatted nut flour, vegetable oil and esterified propoxylated glycerol composition.

If a stabilizer is present, it may be selected from among any of the substances known in the art to be suitable for use as stabilizers in nut butter compositions, i.e., substances which are effective to prevent liquid oils from separating from the other components of a nut butter composition during prolonged storage. Suitable stabilizers include, for example, partially hydrogenated fats, completely hydrogenated fats, and monoglyceride and diglyceride esters of saturated fatty acids. Palm oil stearin is an example of a suitable stabilizer. The nut butter composition may contain, in various embodiments of the invention, 0% or from about 0.1 to about 1% by weight of one or more stabilizers.

The nut butter composition may be formulated to have a protein content of from about 7.5 to about 11.0 grams per 32 gram serving size, a caloric content of from about 110 to about 160 calories per 32 gram serving size, and/or a carbohydrate content of from about 4.0 to about 6.5 grams per 32 gram serving size. The nut butter composition may provide from about 60 to about 95 calories from fat per 32 gram serving.

Additionally provided by the present invention is a method of making a reduced calorie and reduced fat nut butter composition in accordance with the above, comprising blending at least the following components:

a) defatted nut flour;

b) vegetable oil; and

c) an esterified propoxylated glycerol composition having an average propoxylation number of from about 4 to about 6, an Iodine Value greater than 10, a Mettler drop point of at least about 38° C., and a solid fat content profile as follows:
about 65 to about 75 at 10° C.;
about 58 to about 68 at 20° C.;
about 43 to about 55 at 25° C.;
about 30 to about 40 at 30° C.;
about 18 to about 25 at 35° C.; and
less than about 0.5 at 40° C.

### DETAILED DESCRIPTION OF THE INVENTION

The reduced calorie and reduced fat nut butter compositions provided by the present invention comprise defatted nut flour, vegetable oil, and particular types of esterified propoxylated glycerol compositions. Optionally, the nut butter compositions may contain one or more additional ingredients, as will be explained in more detail subsequently.

Esterified propoxylated glycerol compositions useful in the present invention are characterized by having an average propoxylation number of from about 4 to about 6, an Iodine Value greater than 10 (preferably at least 15), a Mettler drop point of at least about 38° C., and a solid fat content profile as follows:
about 65 to about 75 at 10° C.;
about 58 to about 68 at 20° C.;
about 43 to about 55 at 25° C.;
about 30 to about 40 at 30° C.;
about 18 to about 25 at 35° C.; and
less than about 0.5 at 40° C.

Esterified propoxylated glycerols (EPGs) are structurally similar to triglycerides but contain reacted propylene oxide units (oxypropylene moieties) between the glycerol and fatty acid chains to form “extended” glycerides. EPGs are not recognizable by lipases and fat digesting enzymes, and are passed through the digestive tract essentially intact, thus providing fewer calories than triglycerides. The nut butter products described herein have textural or taste benefits including at least one of reduced waxiness, improved mouthmelt or mouthfeel, enhanced ability to be smoothly and easily spread (particularly at room temperature), as well as a prevention of the undesirable laxative effect of passive oil loss through the anal sphincter, which might otherwise occur following the ingestion of EPGs that are liquid at human body temperature. Methods of formulating such food products are also provided.

Any of the methods known in the art to be suitable for the synthesis of esterified propoxylated glycerols may be adapted for use in the preparation of the esterified propoxylated glycerols to be utilized in the present invention. Typically, such methods involve the esterification of propoxylated glycerol with fatty acids. Following esterification, the product obtained may be subjected to further processing to enhance its color, lower the free (unreacted) fatty acid content, remove off-odors and flavors, and other such refining steps. Particularly suitable EPG synthesis methods include, for example, the procedures described in U.S. Pat. No. 8,354,551, incorporated herein by reference in its entirety for all purposes. Other patents which describe EPG synthesis procedures which may be adapted for use in preparing the esterified propoxylated glycerols of the present invention include U.S. Pat. Nos. 4,983,329; 5,175,323; 5,304,665; 5,399,728; 5,603,978; 5,641,534; and 5,681,939, each of which is incorporated herein by reference in its entirety for all purposes.

The esterified propoxylated glycerol compositions used in the present invention have degrees of propoxylation (propoxylation numbers) of about 4 to about 6. That is, the EPG molecules present in the composition contain, on average, from about 4 to about 6 molecules of reacted propylene oxide per molecule of glycerol (i.e., on average about 4 to about 6 oxypropylene units per molecule are present). In various embodiments of the invention the EPG composition may have a degree of propoxylation (i.e., a propoxylation number) of about 4, about 5, about 6, about 4 to about 5, or about 5 to about 6. When glycerol is reacted with propylene oxide, the three hydroxyl groups of the glycerol molecule are each available to react, typically providing a statistical distribution of the oxypropylene units. As a result, the propoxylated glycerol composition thereby obtained (which subsequently is typically esterified with fatty acid(s) to provide the EPG composition) generally is a mixture of different types of propoxylated glycerol molecules (when, for example, the degree of propoxylation is 5, most of the molecules will contain 5 reacted propylene oxide molecules per molecule of propoxylated glycerol, but some amount of propoxylated glycerol molecules will be present which contain less than, or more than, 5 reacted propylene oxide molecules per molecule).

In accordance with one aspect of the present invention, the propoxylated glycerol is esterified with a mixture of fatty acids which is selected to provide an esterified propoxylated glycerol composition with a Mettler drop point of at least about 37° C., e.g., from about 38° C. to about 43° C. or from about 39° C. to about 40° C. Mettler drop point may be measured by AOCS method Cc 18-80. As measured by DSC (Differential Scanning calorimetry), the melting point of such compositions is generally at least about 36° C., e.g., from about 36° C. to about 40° C. In particular, a DSC analysis may be carried out in accordance with the following procedure:

A 17.200 mg sample is placed in an aluminum DSC sample cup of known mass, which is then placed in a DSC Q2000 instrument (version 24.11). The sample is equilibrated at 15.00° C., and then heated to 100.00° C. at 5° C./min. The sample is held at 100° C. for 2 minutes, and then cooled to 0.00° C. at 5° C./min. A crystallization peak is recorded. The sample is held at 0.00° C. for 2 minutes, and then heated to 100° C. at 5° C./min. A melting peak is recorded. All cycles are performed under nitrogen.

The fatty acid composition may be additionally chosen such that the esterified propoxylated glycerol composition has the following solid fat content profile:
about 65 to about 75 at 10° C.;
about 58 to about 68 at 20° C.;
about 43 to about 55 at 25° C.;
about 30 to about 40 at 30° C.;
about 18 to about 25 at 35° C.; and
less than about 0.5 at 40° C.

In certain embodiments, the solid fat content of the esterified propoxylated glycerol composition at 27° C. (80° F.) is not greater than 49, not greater than 48 or not greater than 47.

The solid fat content of an esterified propoxylated glycerol over the temperature range of 10° C. to about 40° C. may be measured by NMR using AOCS Cd 16b-93.

Such EPG compositions thus exhibit a relatively “flat” melting profile, in that they contain substantial proportions of soft fat at typical ambient temperatures of 10° C. to 30° C., and yet have relatively high Mettler drop points (e.g., about 39° C. to about 40° C.). Typically, the DSC melting point of such EPG compositions is from about 36° C. to about 39° C. Thus, at around room temperature, the EPG compositions are relatively soft and even spreadable (e.g., capable of being smoothly and easily coated onto a substrate using a knife, for example), particularly when blended with liquid vegetable oil (which may form a eutectic blend with the EPG composition), and generally do not have a waxy texture when tasted. At the same time, however, these esterified propoxylated glycerol compositions exhibit no passive oil loss after being ingested, by virtue of having Mettler drop points above normal human body temperature. This combination of attributes is quite desirable, yet prior to the present invention it was not known how to attain such properties simultaneously.

In one aspect of the invention, the fatty acid content of the esterified propoxylated glycerol composition is selected to provide a penetration value at 25° C. as measured by ASTM D 1321-04 of from about 110 to about 150 dmm. In this test method, the sample is heated to at least 17° C. above its melting point, poured into a container, and left at ambient temperature to solidify. Then, the sample is conditioned at 25° C. for 24 hours. Penetration is measured with a penetrometer, which applies a standard needle to the sample for 5 seconds under a load of 100 g.

In one embodiment of the invention, esterified propoxylated glycerol compositions having the aforementioned characteristics are provided by utilizing a fatty acid mixture to esterify a propoxylated glycerol having an average degree of propoxylation of about 4 to about 6 wherein the fatty acid mixture contains C20-C22 saturated fatty acid, C18 unsaturated fatty acid, C16-C18 saturated fatty acid, and, optionally, a minor amount of one or more other types of fatty acid. Without wishing to be bound by theory, it is believed that the inclusion of ester groups derived from long chain (C20-C22) saturated fatty acids such as behenic acid helps to achieve a Mettler drop point of at least about 38° C. while the presence of ester groups derived from the unsaturated fatty acid(s) assists in “flattening” the melting profile (i.e., increasing the proportion of soft fat in the composition at temperatures of 10° C. to 35° C.).

In particular, in one aspect of the invention, a propoxylated glycerol having a degree of propoxylation of about 5 is esterified with a fatty acid composition comprising about 50 to about 70% by weight C20-C22 saturated fatty acid (e.g., arachidic acid plus behenic acid), about 20 to about 30% by weight of one or more C18 unsaturated fatty acids, and, optionally, up to about 5% by weight of one or more fatty acids other than behenic acid, C18 unsaturated fatty acids and C16-C18 saturated fatty acids. The balance of the fatty acid composition, to a total of 100% by weight, consists of one or more C16-C18 saturated fatty acids. The use of such a fatty acid composition has been found to provide an esterified propoxylated glycerol composition that is especially suitable for spreadable nut butters.

If a propoxylated glycerol having a higher degree of propoxylation (e.g., about 6) is employed, the proportion of C20-C22 saturated fatty acid in the fatty acid mixture used for esterification may be increased in order to still attain a Mettler drop point of at least about 38° C. If a less propoxylated glycerol is used (e.g., a propoxylated glycerol having a degree of propoxylation of about 4), then the proportion of C20-C22 saturated fatty acid in the fatty acid mixture can be decreased relative to the other types of fatty acids, provided that the Mettler drop point of the resulting EPG composition is still at least 38° C. or higher. To avoid a waxy mouthfeel when the nut butter containing the EPG composition is consumed, it will generally be desirable to select an amount of C20-C22 saturated fatty acid incorporated into the EPG composition such that the Mettler drop point of the EPG composition is not greater than about 42° C. or not greater than about 40° C.

Suitable C20-C22 saturated fatty acids include eicosanoic (arachidic) acid and docosanoic (behenic) acid and combinations thereof. In one embodiment of the invention, behenic acid is used as the predominant or sole C20-C22 saturated fatty acid. Behenic acid is obtainable by the hydrogenation and splitting of rapeseed oil (high erucic canola oil) as well as from other naturally occurring triglycerides having high proportions of C22 unsaturated fatty acids such as fish oils.

Suitable C18 unsaturated fatty acids include mono-, di- and tri-unsaturated fatty acids such as oleic acid, linoleic acid, linolenic acid and combinations thereof. In one embodiment, the oleic acid is present in a weight amount that is greater than the weight amount in total of linoleic acid and linolenic acid.

Suitable C16-C18 saturated fatty acids include, for example, palmitic acid and stearic acid.

The fatty acids other than C20-C22 saturated fatty acids, C18 unsaturated fatty acids and C16-C18 saturated fatty acids which may be used in relatively minor amounts for esterification of the propoxylated glycerol include, for example, C8-C14 saturated fatty acids and unsaturated fatty acids other than C18 unsaturated fatty acids and combinations thereof. Such fatty acids include, for example, caprylic acid, pelargonic acid, capric acid, lauric acid, myristic acid, palmitoleic acid, gadoleic acid, erucic acid, myristoleic acid, arachidonic acid and combinations thereof.

The C18 unsaturated fatty acids and C16-C18 saturated fatty acids may be derived from any suitable source, including by splitting (hydrolysis) of naturally occurring triglycerides such as vegetable oils, vegetable fats, animal fats, animal oils, and the like. A good source of highly concentrated oleic acid is tall oil, a by-product of wood pulp manufacture using coniferous trees. Pamolyn™ (available from Eastman Chemical Company) is a brand name oleic acid approved for food use that can be used for as a source of C18 unsaturated fatty acids in the synthesis of spreadable EPG. Hydrogenation of such oils and fats before or after splitting may be employed to increase the proportion of saturated fatty acids present, if so desired. Illustrative, non-limiting examples of suitable sources of such fatty acids include soybean oil, sunflower oil, safflower oil, peanut oil, olive oil, coconut oil, canola oil, cottonseed oil, tallow, lard, palm oil, palm kernel oil, and partially or fully hydrogenated derivatives thereof, fractionates thereof, and combinations thereof. The optional fatty acids other than behenic acid, C18 unsaturated fatty acids and C16-C18 saturated fatty acids may be supplied separately or as minor components of feedstocks obtained from the aforementioned triglycerides and derivatives thereof.

In one embodiment of the invention (where the EPG composition has a degree of propoxylation of about 5), from about 70 to about 80% by weight of the fatty acid mixture is comprised of saturated fatty acids, the balance (about 20 to about 30% by weight) being unsaturated fatty acids.

Iodine number (also referred to as iodine value) may be measured by AOCS method Cd 1-25. The EPG compositions used in the nut butters of the present invention have an iodine value greater than 10 (preferably at least 15), as a result of the presence of unsaturated fatty acid ester groups (e.g., oleates). The iodine value of the EPG composition may be varied as may be desired, but typically is in the range of from about 15 to about 30. Generally speaking, at a constant propoxylation number, higher iodine values will be associated with a “flatter” melting profile (e.g., an EPG composition with a relatively high iodine value will exhibit a broader melting range than an analogous EPG composition with a relatively low iodine value).

The average number of fatty acid acyl group carbons per equivalent of glycerol in the fatty acid-esterified propoxylated glycerol compositions of the invention may be readily calculated from a knowledge of the fatty acid acyl group content (i.e., the chemical structures and relative proportions of the fatty acids used to prepare the compositions). The following formula may be used to calculate this average number (Nₐ) for an esterified propoxylated glycerol composition prepared using fatty acids A and B:

Nₐ=((moles A×no. carbons in A)/moles propoxylated glycerin)+((moles B×no. carbons in B)/moles propoxylated glycerin)

For example, an EPG composition prepared by reacting a mixture of 0.75 moles of stearic acid (a C18 fatty acid), 0.75 moles of oleic acid (also a C18 fatty acid) and 1.5 moles of behenic acid (a C22 fatty acid) with 1 mole of propoxylated glycerol containing an average of 3 oxypropylene units per glycerol will have an average of 60 fatty acid acyl carbons per equivalent of glycerol (i.e., FACN=60). The EPG-05-S (SB1) used in Experiments 1-3 (shown in Table 1 and 2) has an average fatty acid acyl carbon number of 61 (FACN=61).

While the fatty acid carbon number and melting point have a direct correlation, there is an inverse relationship between the propoxylation number (“PO”) of the EPG compound and the melting point of the compound. Thus, the proper control of the FACN:PO Ratio is necessary to obtain an EPG with the appropriate properties to provide for an organoleptically acceptable product that will not possess undesirable gastrointestinal intolerance and passive oil loss and may not require the use of stabilizers. If this ratio is too high the resulting product will be too firm, have a waxy texture and possess poor spreadability. If this ratio is too low, the resulting product may require the use of a stabilizer and could lead to passive oil leakage. For purposes of the present invention, it will be advantageous for the FACN:PO Ratio to be, for example, in the range of from about 11.5 to about 13.4.

The esterified propoxylated glycerol compositions of the present invention are particularly suitable for use as replacements for nut oils such as peanut oil of the type conventionally used in preparing nut butters such as peanut butter. The EPG compositions may be used to replace conventional fat as the roasting medium in formulating the nut butter compositions or used otherwise, such as directly blended or mixed with other nut butter ingredients prior to or after roasting.

Conventional nut butter manufacturing processes may be adapted to produce the reduced calorie nut butters of the invention except that certain esterified propoxylated glycerol compositions are used to partially replace the digestible oils typically present in nut butters. Based on the total weight of the nut butter composition, the EPG content may be up to about 45%, advantageously about 26% to about 35% by weight.

In addition to the aforementioned EPG compositions, the nut butters of the present invention contain one or more vegetable oils. The vegetable oils may be oils which are completely liquid at room temperature (25° C.). In one embodiment of the invention, the vegetable oil employed is the oil of the nut from which the defatted nut flour is derived. For example, where the nut butter is a peanut spread, the vegetable oil may be peanut oil with the defatted nut flour being defatted peanut flour. Other exemplary vegetable oils suitable for use in the present invention include, without limitation, soybean oil, sunflower oil, safflower oil, olive oil, coconut oil, canola oil, cottonseed oil, palm oil, palm kernel oil, hazelnut oil, cashew oil, almond oil, walnut, filbert oil, macadamia nut oil, pistachio oil, Brazil nut oil, pecan oil, sunflower seed oil, pumpkin seed oil, sesame seed oil and partially or fully hydrogenated derivatives thereof, fractionates thereof, and combinations thereof. In certain embodiments of the invention, the amount of esterified propoxylated glycerol composition is from 50 to 60 weight % and the amount of vegetable oil is from 40 to 50 weight %, such amounts being based on the total weight of esterified propoxylated glycerin composition+vegetable oil. Maintaining the weight amounts within these ranges has been found to impart good spreadability at room temperature to the resulting nut butter. Combining esterified propoxylated glycerin compositions with vegetable oils forms eutectic blends, which when present in a nut butter composition helps to promote spreadability of the nut butter. Further information regarding the ability of esterified propoxylated glycerin compositions to form eutectic blends with triglycerides may be found in U.S. Pat. No. 8,715,764, the disclosure of which is incorporated herein by reference in its entirety for all purposes.

The defatted nut flour employed as a further component of the nut butters of the present invention may be a fully or partially defatted nut flour. Combinations of different defatted nut flours may also be used. The nut flour may, for example, have a fat content of from 0% to about 15% by weight, e.g., a nut flour containing from about 0.5% to about 5% by weight fat, from about 0.5% to about 1% by weight fat, from about 10% to 15% by weight fat, or about 10% to about 12% by weight fat, or mixtures of such defatted nut flours may be utilized. The defatted nut flour or combination of defatted nut flours is selected based on the type of nut butter which is desired, since the defatted nut flour will generally be substantially responsible for imparting the characteristic flavor, taste and aroma to the nut butter. For example, when it is desired to prepare a peanut spread, at least a portion of the defatted nut flour will be a defatted peanut flour or combination of defatted peanut flours. Other examples of suitable defatted nut flours include, but are not limited to, defatted hazelnut flour, defatted cashew flour, defatted almond flour, defatted walnut flour, defatted filbert flour, defatted macadamia nut flour, defatted pistachio flour, defatted Brazil nut flour, defatted pecan flour, defatted sunflower seed flour, defatted pumpkin seed flour, defatted sesame seed flour, defatted coconut flour and the like and combinations thereof. The defatted nut flour may be roasted or otherwise processed to enhance the organoleptic qualities of the resulting nut butter. The fully and/or partially defatted nut flour may constitute, for example, at least about 25% by weight of the total nut butter composition or not more than about 60% by weight of the total nut butter composition (e.g., from about 30% to about 55% by weight of the total nut butter composition).

The nut butters of the invention optionally may additionally include full-fat nuts, for example in amounts of from 0% to about 30% by weight of the nut butter. In one embodiment, however, the nut butter is free of full-fat nuts. The full-fat nuts, if present, may be utilized in ground (milled) or paste form or in pieces or in a combination of paste and pieces form. In one embodiment, fully and/or partially defatted peanuts are used in an amount from about 0% to about 10% by weight of the nut butter. In other embodiments, the nut butter composition may be comprised of from about 5 to about 30% by weight peanut paste.

The esterified propoxylated glycerol compositions of the present invention are particularly suitable for use as replacements for nut oils such as peanut oil of the type conventionally used in preparing nut butters such as peanut butter. The EPG compositions may be used to replace conventional fat as the roasting medium in formulating the nut butter compositions or used otherwise, such as directly blended or mixed with other nut butter ingredients prior to or after roasting.

In addition to the fatty acid-esterified propoxylated glycerol composition, the defatted nut flour and the vegetable oil, the nut butter products of the invention may further comprise one or more other conventional ingredients. Such conventional ingredients include, but are not limited, to full fat nuts and/or partially and fully defatted nuts (at least a portion of which may be in paste form), natural and/or artificial sweeteners, carbohydrate solids, salt, flavorants and other additives such as flavored candies and bits, and the like.

Further caloric reduction can be attained in the nut butters through the use of low calorie bulking agents, which typically contribute 0 to about 1.5 calories per gram. They can include such bulking agents as polydextrose (e.g., LITESSE® from Cultor Food Science), inulin (e.g., RAFTILINE® from Rhone Poulenc, Food Ingredients Division or FRUTAFIT® from Imperial Suiker Unie) and microcrystalline cellulose (e.g., AVICEL® or INDULGE™ from FMC Corp., Food Ingredients Division). Maltodextrin may also be used as a low calorie bulking agent.

Sweeteners and other carbohydrates such as sugar, sugar syrups, corn syrup (including high fructose corn syrup), corn syrup solids, invert sugar, molasses or high potency sweeteners can be used alone or in combination in amounts of, for example, from about 0% to about 7% of the nut butter composition. When the sweetener is sugar, for example, it may be added in an amount from about 2% to about 5%, preferably from about 2% to about 3%, by weight based on the total weight of the nut butter composition. Other conventional natural sweeteners can be employed such as honey and dextrose (glucose), and other carbohydrate solids can be employed such as maltodextrins and starches. Artificial high potency sweeteners such as aspartame, acesulfame K, saccharin and sucralose and natural high potency sweeteners such as stevia extracts (containing steviol glycosides), monk fruit extracts (containing mogrosides) and the like also can be used for further caloric reduction. The amount of natural and/or artificial sweeteners employed will vary depending upon the sweetness desired as will be apparent to those skilled in the art.

The reduced calorie nut butter can also contain salt. The salt may, for example, be used in an amount of from about 1% to about 2% by weight based on the total weight of the nut butter composition.

Nut butter compositions comprising EPG in accordance with the present invention may be made by adaptation of methods known in the art for making conventional nut butters. Reduced calorie peanut butter spreads comprising EPG may, for example, be made by the procedure described below.

Ingredients for making peanut butter spreads in the laboratory using three different recipes are listed in Table 1 below (the percentages stated are in weight %).

TABLE 1

| | | | Example 3 |
|---|---|---|---|
| | Example 1 | | Light recipe with |
| | Reduced | Example 2 | peanut flour |
| Ingredients in peanut butter | fat/calorie | Light recipe, | only |
| spreads | recipe, g (%) | g (%) | g (%) |
| Peanut paste from roasted peanuts | 135 g (27%) | 78 g (15.6%) | — |
| (ground, salted, peanuts, 48.4% fat) | | | |
| Defatted peanut flour, light roast | 165 g (33%) | 210 g (42%) | 262.5 g (52.5%) |
| (12% fat) | | | |
| EPG (melting point 39° C., 102.2° F.) | 131 g (26.2%) | 143 g (28.6%) | 142.5 g (28.5%) |
| Peanut oil | — | 46 g (9.2%) | 70 g (14%) |
| Vegetable oil | 36 g (7.2%) | — | — |
| Sucrose (confectionery sugar) | 15 g (3%) | 15.5 g (3.1%) | 15 g (3%) |
| Molasses | 10.5 g (2.1%) | — | — |
| Stabilizer (palm oil stearin) | 2.5 g (0.5%) | 2.5 g (0.5%) | 2.5 g (0.5%) |
| Salt (finely ground) | 5 g (1%) | 5 g (1%) | 7.5 g (1.5%) |
| Total recipe | 500.00 g (100%) | 500.00 g (100%) | 500 g (100%) |

Weigh roasted, slightly salted peanuts and light roast defatted peanut flour in separate bowls of appropriate size.
Weigh dry ingredients (confectioners' sugar, salt powder, peanut butter stabilizer) in separate small plastic cups.
Scoop solid EPG (at about 70° F.) with a spoon into a 1000 ml glass beaker. Weigh the required amount and add vegetable oil or peanut oil as called for by the recipe. Add peanut butter stabilizer. Heat EPG/oil/stabilizer mixture in a microwave for 2 minutes at 40% power. Wait until EPG and stabilizer melt completely. Swirl the EPG/oil blend in the beaker and check temperature. It should be about 140° F. (60° C.). Mix liquid oil blend thoroughly using magnetic stirrer or overhead mixer. Remove magnetic bar (it will stick to small spoon or fork).
Grind peanuts on coarse setting in peanut butter maker. Warm up peanut butter paste obtained to 140° F. in a microwave for 30 seconds on 40% power setting.
Combine warm peanut paste with warm EPG/oil blend in a 1000 ml beaker. Add sugar, molasses (if required by recipe), salt and defatted peanut flour. Mix contents of the beaker thoroughly for 1 minute using hand-held blender. Temperature of the liquid mass should be about 130° F.
Mill the mass in peanut butter maker on smooth setting. Temperature of the milled mass exiting peanut butter maker should be about 120° F. (49° C.).
Insert the container with milled mass into a portable vacuum chamber. Apply vacuum for at least 5 minutes or until no air bubbles are visible on the surface. Swirl gently the container to aid air bubbles migration to the surface. Introduce nitrogen into the vacuum chamber and discontinue vacuum. Removing air under vacuum and nitrogen blanketing are recommended to ensure shelf stability of peanut spread and to prevent liquid oil pooling into air pockets.
Pour the still liquid mass (about 110° F.) into clean jars and cap while warm.
Leave at ambient temperature for 12 hours to solidify (without refrigeration).

The nut butters of the present invention may be sold and consumed as such, or may be utilized as components in the manufacture of other food products. The nut butter may, for example, be used as a confectionary filling, a cookie filling or ingredient, a savory snack filling or ingredient, or as an ingredient in frozen desserts such as ice cream products and the like.

Peanut spreads formulated in accordance with the present invention are capable of exhibiting more balanced nutritional values as compared to conventional, commercial products, without any significant functionality trade-offs such as flavor, texture, mouthfeel and spreadability. Compared to regular (full fat) peanut butter, peanut spreads containing esterified propoxylated glycerol compositions according to the present invention may have one or more of the following characteristics:
Total calories are reduced by 27% to 40%;
Calories from fat are reduced by 40% to 52%;
Carbohydrates are reduced by 23.8% to 32.5%;
Protein is increased by 12.8 to 28.6%; and
Fiber is increased by 15%.

Compared to conventional, commercial reduced fat peanut spreads, the advantages of peanut spreads in accordance with the present invention include:
Total calories are reduced by 27% to 40%;
Calories from fat are reduced by 37% to 43%;
Carbohydrates are reduced by 53% to 58%;
Protein is increased by 12.8% to 28.6%; and
Fiber is increased by 15%.

### EXAMPLES

Exemplary peanut spreads in accordance with the present invention (Examples 1, and 2) are prepared using the ingredients listed in Table 1, and an esterified propoxylated glycerol composition (EPG-05-S (SB1)) prepared by esterifying propoxylated glycerol having a degree of propoxylation of about 5 with palmitic (0.5%), stearic (8.8%), oleic (20.6%), linoleic (1.4%), arachidic (46.9%), behenic (21.4%) and minor other (0.4%) fatty acids having an estimated caloric content of 0.7 Kilocalories per gram and an Iodine Value of 18.2. DSC analysis shows a melting peak at 38.7° C. and a crystallization peak at 34.43° C. The solid fat content of the esterified propoxylated glycerol composition at various temperatures is as follows:

| Temperature (° C.) | Solid Fat Content |
|---|---|
| 10 | 73.4 |
| 20 | 64.9 |
| 25 | 52.1 |
| 27 | ca. 46 |
| 30 | 36.8 |
| 35 | 23.6 |
| 40 | 0 |

A high protein peanut spread having a higher content of roasted defatted peanut flour is also shown (Example 3). The characteristics of these peanut spreads are set forth in Table 2 and compared to those of a conventional peanut butter (Comparative Example A, made with peanuts, evaporated cane juice, palm oil, salt and molasses) and a conventional reduced fat peanut spread (Comparative Example B, made with roasted peanuts, corn syrup solids, soy protein, molasses, salt, fully hydrogenated vegetable oil and various vitamins and minerals).

TABLE 2

| | A | B | Example 1 | Example 2 | Example 3 |
|---|---|---|---|---|---|
| | (Comparative) | (Comparative) | (Invention) | (Invention) | (Invention) |
| Serving Size, g | 32 | 35 | 32 | 32 | 32 |
| Est. Calories | 190 | 190 | 139 | 114 | 130 |
| EPG | — | — | 8.4 g | 9.2 g | 9.1 g |
| | | | (26.2%) | (28.6%) | (28.5%) |
| Oil | 16 g | 12 g | 7.6 g | 6.8 g | 6.9 g |
| | (50%) | (25%) | (23.8%) | (21.2%) | (21.6%) |
| Calories from | 130 | 110 | 78 | 62 | 68 |
| fat | | | | | |
| Functional fat | 16 g | 16 g | 16 g | 16 g | 16 g |
| Ratio of EPG | — | — | 51:49 | 55:45 | 56:44 |
| to total oil in | | | | | |
| recipe | | | | | |
| Carbohydrates | 8 | 13 | 6.1 | 5.6 | 5.4 |
| Protein | 7 g | 7 g | 7.9 g | 8.6 g | 9.0 g |
| Fiber | 2.0 | 2.0 | 2.3 | 2.3 | 2.3 |

1. A nut butter composition comprising:
a) defatted nut flour;
b) vegetable oil; and
c) an esterified propoxylated glycerol composition having an average propoxylation number of from about 4 to about 6, an Iodine Value greater than 10, a Mettler drop point of at least about 38° C., and a solid fat content profile as follows:
about 65 to about 75 at 10° C.;
about 58 to about 68 at 20° C.;
about 43 to about 55 at 25° C.;
about 30 to about 40 at 30° C.;
about 18 to about 25 at 35° C.; and
less than about 0.5 at 40° C.
wherein the nut butter composition has a caloric content of from about 110 to about 160 calories per 32 gram serving size and provides from about 60 to about 95 calories from fat per 32 gram serving size.

2. The nut butter composition of claim 1, wherein the defatted nut flour is a roasted defatted nut flour.

3. The nut butter composition of claim 1, wherein the defatted nut flour is defatted peanut flour.

4. The nut butter composition of claim 1, wherein the vegetable oil is a nut oil.

5. The nut butter composition of claim 1, wherein the vegetable oil is peanut oil.

6. The nut butter composition of claim 1, comprising about 30 to about 55 weight % of defatted nut flour.

7. The nut butter composition of claim 1, comprising from about 5 to about 30 weight % of vegetable oil.

8. The nut butter composition of claim 1, comprising about 20 to about 40 weight percent of the esterified propoxylated glycerol composition.

9. The nut butter composition of claim 1, wherein the esterified propoxylated glycerol composition has an average propoxylation number of about 5.

10. The nut butter composition of claim 1, additionally comprising at least one further ingredient selected from the group consisting of salt and sweeteners.

11. The nut butter composition of claim 1, wherein the nut butter composition does not contain a stabilizer.

12. The nut butter composition of claim 1, wherein the nut butter composition does not contain a bulking agent.

13. The nut butter composition of claim 1, wherein the nut butter composition has a protein content of from about 7.5 to about 11.0 grams per 32 gram serving size.

14. (canceled)

15. The nut butter composition of claim 1, wherein the nut butter composition has a carbohydrate content of from about 4.0 to about 6.5 grams per 32 gram serving size.

16. (canceled)

17. The nut butter composition of claim 1, wherein the esterified propoxylated glycerol contains fatty acid ester groups obtained from a fatty acid mixture comprised of about 5 to about 30 weight percent liquid soybean oil fatty acids and about 50 to about 70 weight percent in total of arachidic and/or behenic acid, with the balance of the fatty acids selected from the group consisting of stearic acid, palmitic acid and combinations thereof.

18. The nut butter composition of claim 1, wherein the esterified propoxylated glycerol composition is the reaction product of glycerol propoxylated with an average of about 5 moles of propylene oxide per mole of glycerol that has been esterified with a fatty acid composition comprised of:
a) about 50 to about 70% by weight of one or more C20-C22 saturated fatty acids;
b) about 20 to about 30% by weight of one or more C18 unsaturated fatty acids;
c) up to about 5% by weight of one or more fatty acids other than C20-C22 saturated fatty acids, C18 unsaturated fatty acids and C16-C18 saturated fatty acids; and
d) the balance to a total of 100% by weight of one or more C16-C18 saturated fatty acids.

19. The nut butter composition of claim 1, wherein the Mettler drop point of the esterified propoxylated glycerol composition is at least about 38° C. and not more than about 40° C.

20. The nut butter composition of claim 1, wherein the esterified propoxylated glycerol composition has an average number of fatty acid acyl group carbons per propoxylation number in the range of from about 11.5 to about 13.4.

21. The nut butter composition of claim 1, wherein the esterified propoxylated glycerol composition has an Iodine Value of from 15 to 30.

22. The nut butter composition of claim 1, additionally comprising peanut paste.

23. The nut butter composition of claim 1, wherein the esterified propoxylated glycerin composition has a penetration value at 25° C. as measured by ASTM D 1321-04 of from about 110 to about 150 dmm.

24. A method of making a nut butter composition, comprising blending at least the following components:
a) defatted nut flour;
b) vegetable oil; and
c) an esterified propoxylated glycerol composition having an average propoxylation number of from about 4 to about 6, an Iodine Value greater than 10, a Mettler drop point of at least about 38° C., and a solid fat content profile as follows:
about 65 to about 75 at 10° C.;
about 58 to about 68 at 20° C.;
about 43 to about 55 at 25° C.;
about 30 to about 40 at 30° C.;
about 18 to about 25 at 35° C.; and
less than about 0.5 at 40° C.
to obtain a nut butter composition having a caloric content of from about 110 to about 160 calories per 32 gram serving size which provides from about 60 to about 95 calories from fat per 32 gram serving size.

25. The nut butter composition of claim 1, wherein the nut butter composition has a functional fat content which is unchanged as compared to a conventional nut butter composition.

26. The nut butter composition of claim 1, wherein the nut butter composition has a functional fat content of 16 grams per 32 gram serving size.
